(19) United States
(12) Patent Application Publication
(10) Pub. No.: US 2010/0147928 A1
(43) Pub. Date: Jun. 17, 2010

(54) METHOD FOR THE MANUAL PLACEMENT OF BOTTOM TERMINATED LEADLESS DEVICE ELECTRONIC PACKAGES USING A MATED STENCIL PAIR

(75) Inventors: Robert P. Wettermann, Inverness, IL (US); Hung Hoang, Romeoville, IL (US); Raymond A. Cirimele, Chicago, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Business Electronics Soldering Technologies, Inc., Rolling Meadows, IL (US)

(21) Appl. No.: 12/635,355

(22) Filed: Dec. 10, 2009

Related U.S. Application Data
(60) Provisional application No. 61/121,358, filed on Dec. 10, 2008.

(51) Int. Cl. B23K 31/02; B23K 3/08

(52) U.S. Cl. 228/180.22; 228/256; 228/57

(57) ABSTRACT

The present invention relates to a process for the rework of bottom terminated leadless devices as well as a pair of stencils for the manual reattachment of such devices (commonly known as a QFN, LGA or MLF packages). This process is used to remount these devices once they have been removed from the printed circuit board or placing new devices on an already populated PCB. It is also used to add bumps to the bottom side of an electronic device package or pads.

### BACKGROUND OF THE INVENTION

In the rework of printed circuit boards, bottom termination leadless devices such as QFNs, LGAs and MLFs must from time to time be removed and replaced by new devices on a populated PCB. Alternatively, removed devices may need to be recaptured and be re-attached. In both cases the attachment/reattachment of the leadless device is important.

In a typical leadless device rework process the pads on the board are paste printed, the device placed and the device reflowed. After component removal, the sites on the PCB are “dressed”, that is the solder is removed from the pads with a solder removal tool or more commonly with solder wick. This is followed by a cleaning process. A miniature metal stencil replicating both the patterns and the thickness of that used in the initial manufacturing process is used to define the area on the PCB where solder paste is to be applied. The solder paste is “rolled” through the apertures in the stencil using a handheld squeegee. Upon stencil removal, the replacement device is placed onto the correct area and reflowed. Typically a split vision system, found on higher end rework equipment, is used to accurately place the device onto the PCB and selectively reflow the device.

In another leadless device rework process, the pads on the device are paste printed and solder “bumps” created, the pads on the PCB fluxed, the device placed and reflowed. In this method, the replacement device, whether new or existing, has the solder pads “bumped” using either a dispense system or via a miniature stencil. After the site on the PCB is “dressed”, the pad locations are fluxed and the device is placed by hand or with a split vision rework system and reflowed into place.

In a third method, after the ground slug of the device is “bumped” and the device is “tacked down” to the board, each of the peripheral pads are then hand-soldered into place. After the device is removed, the bottom side pads of the device have the solder removed and cleaned as in the previous methods. The ground connection then has enough solder flowed onto it such that the overall height of the device off the board is the same as it was prior to its removal. The device is flipped over and the leadless device is “tacked” into place with a hot air source, typically a heat gun. Assuming that there is enough room between the IO pads of the device and the board, someone skilled in hand soldering can then make these solder connections.

In even another method, programmable dispensing equipment is used to apply solder paste selectively on the various pads on the printed circuit board and the device is then placed and reflowed. In particular, the PCB site location is first prepared as previously described. A programmable solder paste dispensing system is then used to dispense solder paste onto the pads on the PCB. This is followed by the placement of the leadless device package onto the PCB with a split vision rework system. Lastly, the device is reflowed according to the solder manufacturers' specifications.

While there are several methods for the removal and replacement of leadless devices, there continues to be the need for a faster, simpler method for the replacement of leadless devices that does not require the use of either highly skilled soldering technicians or high-end rework equipment. The use of these leadless devices, especially as the density of the boards upon which these package types are found increases, continues to proliferate. Therefore, a process by which the less skilled rework technicians could rework the devices would be advantageous.

### BRIEF SUMMARY OF THE INVENTION

An exemplary manual rework process for leadless device packages according to the invention which allows for the replacement of such devices is described herein and shown in the Figures. The process uses a matched pair of polyimide stencils to allow a solder “bumped” leadless device to fit into the apertures of a stay-in-place polyimide stencil affixed to a printed circuit board (PCB) or flex circuit. As used herein, the term printed circuit board or PCB is intended to include both printed circuit boards and flex circuits.

First, a leadless bottom terminated package device is removed from a PCB with a heat source such as a hot air gun, rework station or other heat source. Both the device as well as the PCB lands are then dressed such that excess solder is removed from the lands and cleaned. A polyimide stencil designed to fit over the pads of the leadless device (based on the mechanical device specifications or the actual pad dimensions) is placed onto the bottom side of the device. The adhesive on the stencil is then activated by pushing the stencil onto the bottom of the device. Solder paste is then “rolled” into the apertures. The device is then reflowed.

Upon cooling, the stencil is removed and the bottom of the device is then cleaned. The matched polyimide stencil with apertures designed to accept the “bumps” on the bottom of the device is then aligned, placed and adhered onto the PCB. Solder paste is “rolled” into these apertures with a miniature squeegee and the surface of the stencil is cleaned to remove any solder paste from the top surface. The “bumped” device is then “fitted” into the apertures and the device is reflowed using a heat source.

In some cases, the board side stencil may not be required and the device pads or other electrical contact pads can be simply “bumped” as described above, flux applied to the PCB and the device reflowed. In such cases, no board stencil is necessary.

### BRIEF DESCRIPTION OF THE SEVERAL VIEWS OF THE DRAWING(S)

FIG. 1 is a schematic side view of an illustrative leadless device that can be reworked using a method according to the present invention.

FIG. 2 is a schematic side view showing an illustrative stencil applied to the leadless device of FIG. 1.

FIG. 3 is a schematic side view of the stencil and leadless device of FIG. 2 showing the solder past being squeegeed into the apertures in the stencil.

FIG. 4 is a schematic side view of the stencil and leadless device of FIG. 2 showing the apertures of the stencil filled with solder paste and ready for reflow.

FIG. 5 is a schematic side view of the leadless device after reflow and removal of the stencil.

FIG. 6 is a schematic side view of an illustrative printed circuit board to which the leadless device of FIG. 5 can be attached.

FIG. 7 is a schematic side view of the printed circuit board of FIG. 6 with an illustrative stencil applied to the board.

FIG. 8 is a schematic side view of the printed circuit board and stencil of FIG. 6 showing the solder paste being squeegeed into the apertures in the stencil.

FIG. 9 is a schematic side view of the printed circuit board and stencil of FIG. 6 showing the apertures of the stencil filled with solder paste and ready for reflow.

FIG. 10 is a schematic side view showing the bumped leadless device of FIG. 6 being aligned with the printed circuit board and stencil of FIG. 9.

FIG. 11 is a schematic side view of the bumped leadless device of FIG. 6 attached to the printed circuit board and stencil of FIG. 9.

### DETAILED DESCRIPTION OF THE INVENTION

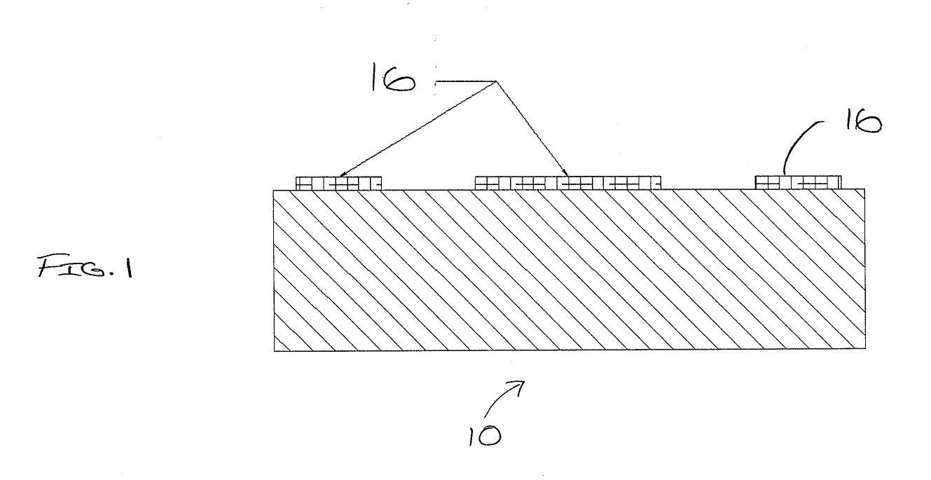

The present invention comprises a manual rework method for leadless device packages 10, such as shown in FIG. 1, which either have either been previously removed from a printed circuit board 11 assembly or for situations in which a new device needs to be placed on an already-populated printed circuit board 11. The method can use a mated pair of polyimide stencils 12, 14, one for the device 10 and one for the printed circuit board 11 (PCB). The stencil 12 for the device 10 is used to selectively “screen” solder paste onto the device lands, contact pads or contact areas 16. The device 10 is then reflowed to produce a “bumped” device. These bumps fit into the apertures of a stay-in-place stencil 14 residing on the PCB 11. As the bumps can be tactilely “fitted” into the apertures (i.e., a technician can feel the bumps entering the apertures), there is no need for high end rework equipment.

The mated pair of stencils 12, 14 can be cut from a single polyimide element that can have several unique characteristics. In particular, the stencils can be an approximately 0.20 to approximately 0.55 mm thick polyimide material with an adhesive backing. The polymide material can be configured with properties that enable it to be laser machinable and to withstand reflow temperatures (e.g., very good thermal stability properties). The adhesive can be pressure-sensitive. The adhesive can be configured to exhibit excellent adhesive properties when activated and adhered to a PCB laminate material even through extended reflow profiles where the temperatures can exceed 270° C. for several minutes.

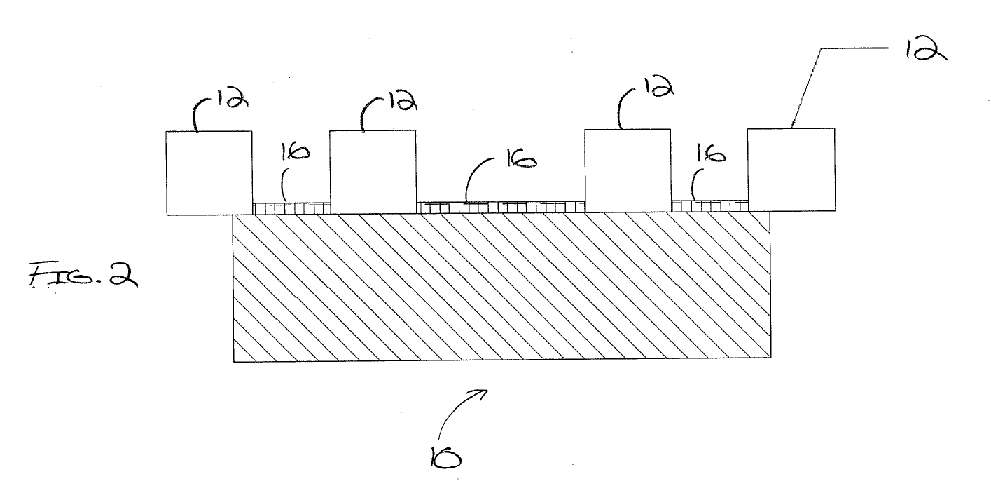

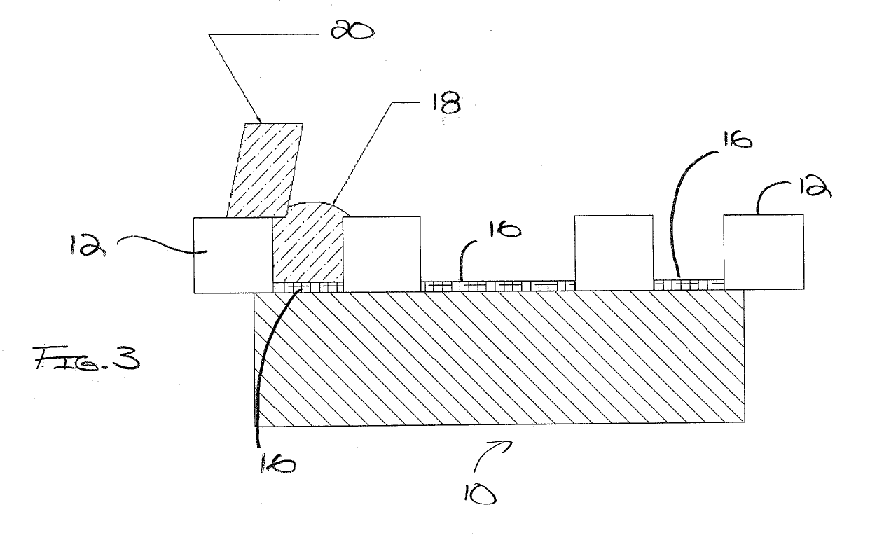

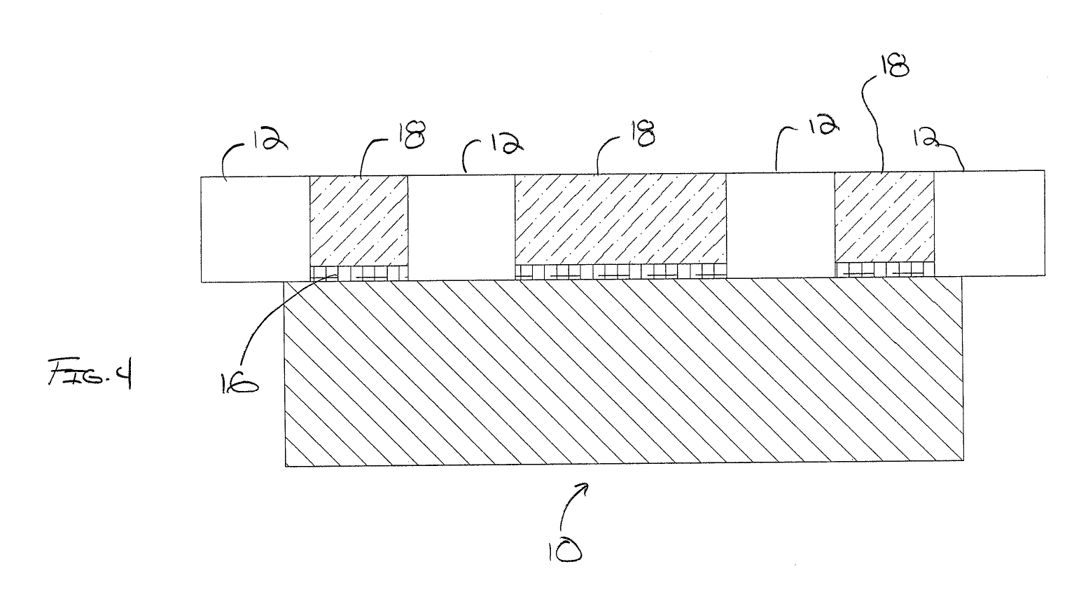

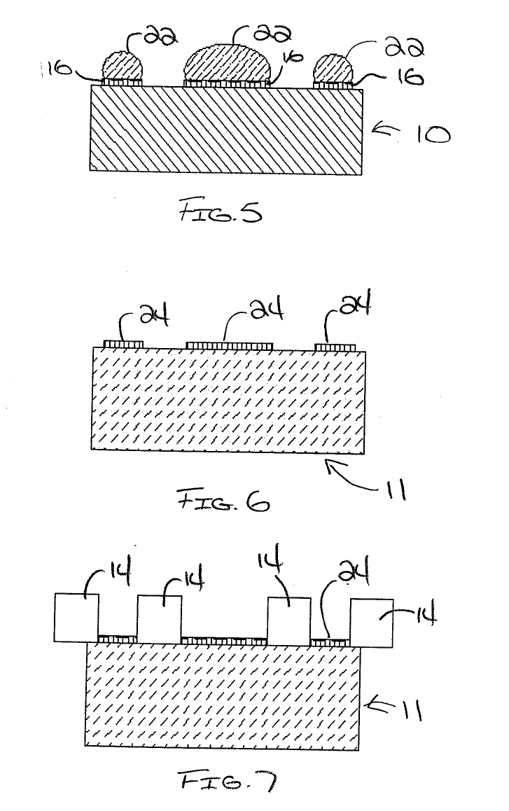

The first of the stencils 12 is designed to be used in selectively applying solder paste 18 onto the bottom side of the device 10. To this end, the stencil 12 has a pattern of apertures that matches the pattern of the contact pads or areas on the device 10. For example, the leadless device 10 is first removed and the pads or contact areas 16 properly dressed (see FIG. 1). The release liner for the adhesive on the stencil 12 is peeled away and placed onto the bottom side of the device 10 (see FIG. 2). Solder paste 18 is then rolled into the apertures in the stencil 12 using a squeegee 20 or other suitable tool (see FIG. 3). The apertures in the stencil 12 and its thickness are configured such that the proper solder paste 18 volume is deposited (see FIG. 4). The device 10 is then reflowed in accordance with the solder paste manufacturer's guidelines. When the device 10 has cooled, the stencil 12 is peeled off and properly cleaned. The result is a device with “bumps” 22 arranged on the bottom side of the device 10 at the location of the pads 16 (see FIG. 5).

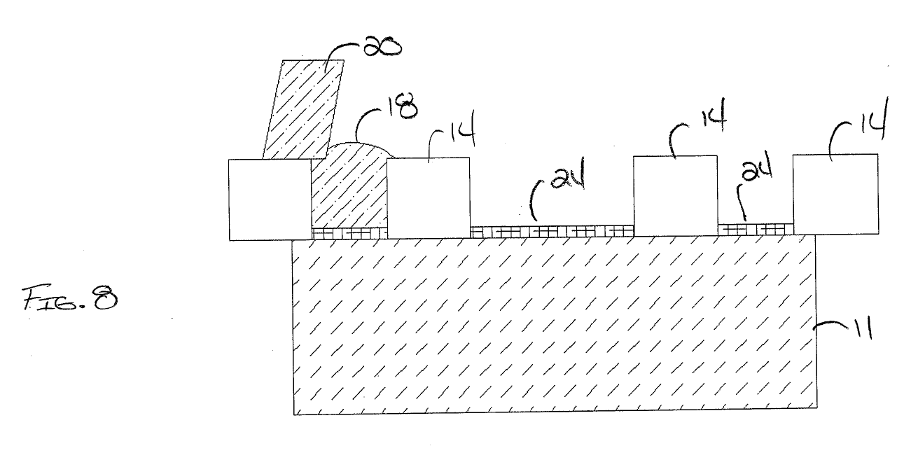

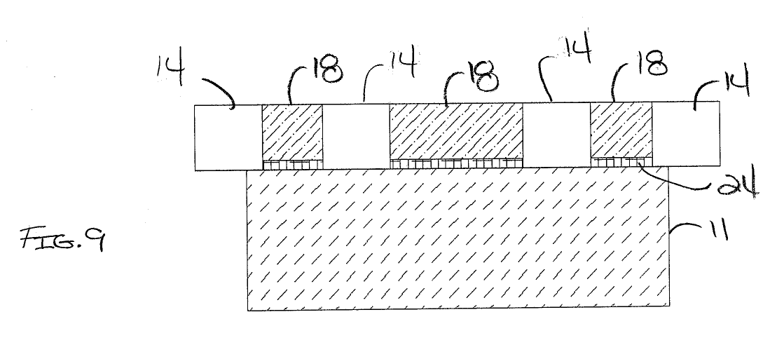

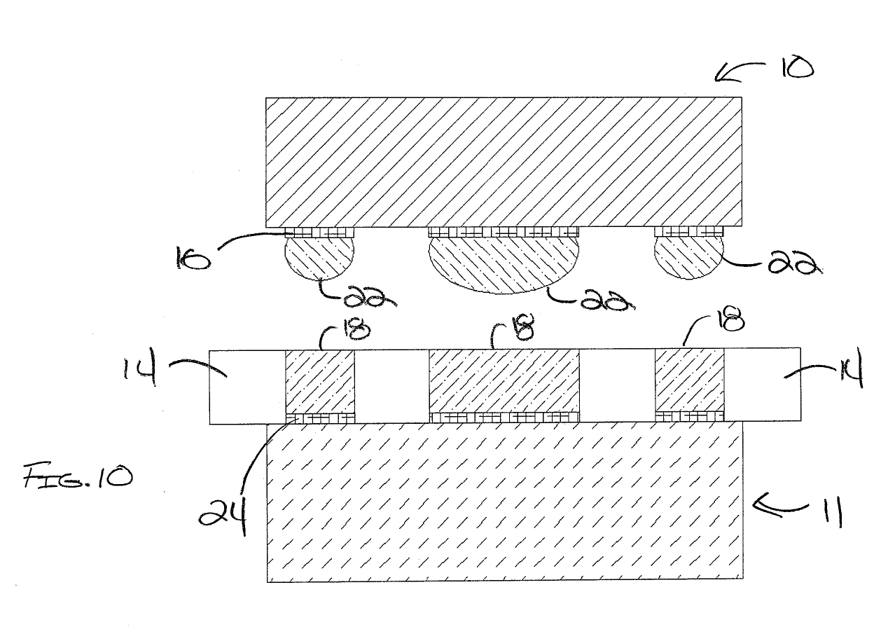

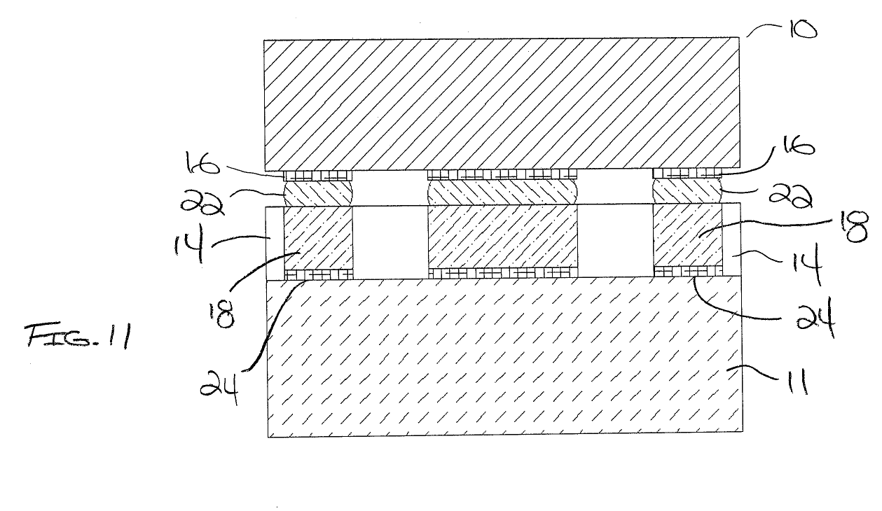

The second of the stencils 14 has apertures designed to match the pattern of contacts or pads 24 on the printed circuit board 11 and into which the “bumps” 22 on the device 10 can fit (see FIG. 6). In a similar manner to the device stencil 12, the release liner is peeled from the mating board stencil 14. It is aligned over the pads 24 of the printed circuit board 11 and the adhesive is activated through the application of pressure (see FIG. 7). Solder paste 18 or flux is then “rolled” via a handheld squeegee 20 or other suitable tool into the apertures of the stencil 14 with the surface afterwards being wiped clean (see FIGS. 8 and 9). The device solder bumps 22 are then fitted into the apertures of the stencil 14 on the PCB 11 and sent through a reflow process (see FIGS. 10 and 11). After doing any necessary or desired cleaning, the device is ready for inspection. Cleaning is not necessary in all cases.

The stay-in-place or printed circuit board stencil 14 and/or the leadless device stencil 12 can have several characteristics including one or more of the following:
The stencils can be fabricated by laser cutting holes that match up to the pad pattern of the device to be reworked.
The stencils can be made of a high temperature (e.g., a 200° C. withstand temperature) polyimide material.
One surface of the stencils can include an adhesive that is protected by a release liner.
The stay-in-place stencil can be made of an electrically insulating material.
The stay-in-place stencil can be configured to provide a quick visual indicator of a repaired site area.
The stay-in-place stencil can be configured such that its apertures are spaced from each other so as to provide a desired dielectric barrier between adjacent contact locations.
The adhesive on the stencils can be made using a high temperature pressure sensitive material
The stencils be made of a material that has high mechanical stability at elevated temperatures
The stencils can provide an insulating material with a thickness between approximately 0.20 mm and 0.55 mm

Another aspect of the invention lies in the fabrication of the matched set of stencils 12, 14. The fabrication method can consist of laser cutting holes into a high temperature non-wettable sheet backed with a (polyimide) thermo pressure adhesive sheet in order to create the correct aperture pattern. Due to the ever-declining pad sizes and increasing IO density, a tool with this type of cutting hole accuracy may be required.

One advantage of the invention is that the placement of the leadless device package 10 is simplified as the user can “feel” the device settle into the apertures of the stencil 14 that is permanently affixed to the printed circuit board 11. The “bumps” 22 created in the process allow users to tactilely fit the bumped device into the corresponding apertures of the stencil 14 on the board 11. This allows the user to hand place the devices without the use of high end rework equipment equipped with a split vision system.

Another advantage of the invention is that the stay-in-place stencil 14 can act as a means for repairing damaged solder mask areas on the printed circuit board 11. There are cases, where upon removal of the device package from the printed circuit board assembly the mask is damaged. Standard procedures call for the mask to be repaired by highly skilled repair technicians working by hand underneath a microscope to “touch up” and repair the mask. This can be a time consuming and lengthy process. The stay-in-place stencil 14 can act as a replacement mask that eliminates the need to repair each of the individual areas by hand.

Yet another advantage of the invention is that the stencils 12, 14 provide a built-in spacer which prevents excessive solder paste from collapse while providing a minimum spacing between the device 10 and the PCB 11.

Another advantage of the invention is that the stencil 14 on the printed circuit board 11 can act as an insulating barrier between solder connection points in that the stay-in-place stencil providing a mask between adjacent solder connections thereby increasing placement reliability.

Another advantage of the invention is that the stenciling technique can enable a technician to rework a warped device or a device that will be placed onto a warped PCB. Since the stencil is held in intimate contact with the PCB or device when the solder paste or flux is applied, any lack of co-planarity in the surface can be overcome.

Another advantage of the invention is that the non-wettable permanently adhered stencils can maintain high surface insulation resistance values as the stencil material can act as a dielectric media between the pads.

A manual method for reattachment of leadless device packages, more commonly described as QFNs, LGAs and MLF package types, is disclosed. This process allows for devices to be reused after they have been removed from the PCB or for the placement of a new device onto a populated PCB.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for manually attaching a leadless device onto a printed circuit boards comprising the steps of:
providing a matched pair of polyimide single use first and second stencils each having a pattern of apertures that corresponds to a pattern of contacts on a surface of the leadless device and a pattern of contacts on surface of the printed circuit board;
aligning the apertures in the first stencil with the pattern of contacts on the leadless device and affixing the first stencil to the surface of the leadless device with an adhesive;
manually squeegeeing solder paste into the apertures in the first stencil;
reflowing the leadless device to attach the solder and produce solder bumps on the contacts on the surface of the leadless device;
removing the first stencil from the surface of the leadless device;
aligning the apertures in the second stencil with the pattern of contacts on the leadless device and applying the second stencil to the surface of the printed circuit board;
manually squeegeeing solder paste into the apertures of the second stencil; and
aligning the solder bumps of the leadless device into the filled apertures of the second stencil on the printed circuit board; and
reflowing the leadless device and printed circuit board to attach the leadless device to the printed circuit board.

2. The method of claim 1 wherein any remnant solider paste is cleaned from the first stencil surface after squeegeeing solder paste into the apertures in the first stencil.

3. The method of claim 1 wherein the surface of the leadless device is cleaned after removing the first stencil from the surface of the leadless device.

4. The method of claim 1 wherein the step of applying the second stencil to the surface of the printed surface board is done by applying pressure to the stencil surface.

5. The method of claim 1 wherein the first and second stencils are made of a polymide material.

6. The method of claim 1 wherein the apertures in the first and second stencils are made by laser cutting.

7. A method for manually reworking a pattern of contacts on a surface:
providing a polyimide single use stencil having a pattern of apertures that corresponds to the pattern of contacts;
aligning the apertures in the stencil with the pattern of contacts and affixing the stencil to the surface with the contacts with an adhesive;
manually squeegeeing solder paste into the apertures in the stencil;
reflowing the surface with the contacts to form solder “bumps” on the contacts on the surface; and
removing the stencil from the surface.

8. The method of claim 7 wherein any remnant solider paste is cleaned from the stencil surface after squeegeeing solder paste into the apertures in the stencil.

9. The method of claim 7 wherein the surface is cleaned after removing the stencil from the surface.

10. The method of claim 7 wherein the first and second stencils are made of a polymide material.

11. The method of claim 7 wherein the apertures in the stencil are made by laser cutting.

12. A stencil set for use in attaching a leadless device having a pattern of contacts onto a printed circuit board having corresponding pattern of contacts comprising:
a pair of polymide stencils each including a plurality of apertures in a pattern that corresponds to the pattern of contacts on the leadless device and the printed circuit board, each stencil having an adhesive on one surface thereof that is protected by a release liner, wherein the stencils are configured for a single-use application.

13. The stencil set according to claim 12 wherein the apertures in the pair of stencils are made by laser cutting.

14. The stencil set according to claim 12 wherein the adhesive is a high temperature pressure sensitive adhesive.

15. The stencil set according to claim 12 wherein each of the stencils is between 0.20 mm and 0.55 mm thick.
